(19) United States
(12) Patent Application Publication
(10) Pub. No.: US 2026/0186812 A1
(43) Pub. Date: Jul. 2, 2026

(54) Virtual Platform Management for FPGA

(71) Applicant: Altera Corporation, San Jose, CA (US)

(72) Inventors: Andrew Draper, Chesham (GB); Sebastian Schoenberg, Hillsboro, OR (US); Paul Rotker, Stow, MA (US); Aanandh Balasubramanian, Bangalore (IN); Aurelien Mozipo, Portland, OR (US)

(21) Appl. No.: 19/002,139

(22) Filed: Dec. 26, 2024

(51) Int. Cl. G06F 9/455

(52) U.S. Cl. CPC G06F 9/45558; G06F 2009/45579

(57) ABSTRACT

Systems, methods, and computer-readable media for on-chip platform management of an integrated circuit device is provided. An integrated circuit device may include programmable logic circuitry and a device controller that includes a processor. The processor may execute instructions to run a hypervisor, a first virtual machine managed by the hypervisor, and a second virtual machine managed by the hypervisor. The first virtual machine may perform a configuration function of the programmable logic circuitry and the second virtual machine may perform a platform management function of the integrated circuit device.

### BACKGROUND

This disclosure relates to systems and methods for managing an integrated circuit device, such as a field programmable gate array (FPGA), using a virtual machine running on the integrated circuit device.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuits are found in numerous electronic devices and provide a variety of functionality. Many integrated circuits include programmable logic circuitry that may be configured with a hardware system design to implement circuitry that may perform a wide variety of different functions. Some programmable logic devices may be FPGA systems running platform management, which involves a separate board management controller (BMC) to act as a platform management controller. This solution adds costs to deploy a programmable logic device. Some programmable logic devices have provided solutions as an additional hard processing subsystem within the FPGA, but this also costs silicon area. An external on-board platform management controller or even an on-chip platform management controller may result in delays for inter-processor communication, making the solution less suitable for high-frequency applications. Examples of such high frequency applications include infrastructure processing units (IPUs) or smart network interface controller (NICs), high-frequency trading, and telecom optical transport networks (OTNs), where there is a dynamic requirement to scale up the frequencies and scale down to conserve energy. In industrial and battery-operated devices, there may be great value in reducing the overall system leakage current while in a sleep state. Additional on-board or on-chip components increase the overall energy and/or leakages.

### BRIEF DESCRIPTION OF THE DRAWINGS

Various aspects of this disclosure may be better understood upon reading the following detailed description and upon reference to the drawings in which:

FIG. 1 is a block diagram of a system used to program a system design onto an integrated circuit device;

FIG. 2 is a block diagram of an example integrated circuit device that may be programmed with a system design;

FIG. 3 is a block diagram of a secure device machine (SDM) and platform management machine (PMM) that may run as virtual machines on a device controller of the integrated circuit device to manage operation of the integrated circuit device;

FIG. 4 is a flowchart of a method for initializing the integrated circuit device using the virtual machines on the device controller;

FIG. 5 is a flowchart of a method for reducing power consumption of the integrated circuit device using the virtual machines on the device controller;

FIG. 6 is a block diagram illustrating secure partitioning of memory regions and dedicated peripherals for the different virtual machines;

FIG. 7 is a diagram illustrating communication between the different virtual machines;

FIG. 8 is a diagram illustrating communication from the PMM to the SDM via an application programming interface (API); and

FIG. 9 is a block diagram of a data processing system that may incorporate the integrated circuit device.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

To avoid the expense and latency of a board management controller (BMC) to run platform management for a programmable logic device such as an FPGA, a processor on the programmable logic device may run virtual machines that may perform these functions. A device controller (e.g., a secure device manager) may provide a platform for a containerized system for running a platform management machine (PMM) alongside a secure device machine (SDM). The PMM may interact with SDM to run configuration of the FPGA, board management solutions, power management, telemetry collection or aggregation, and root-of-trust services such as Calyptra.

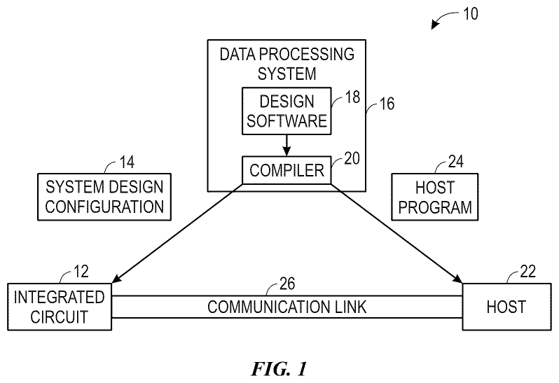

FIG. 1 illustrates a block diagram of a system 10 that may be used to program such an integrated circuit device 12, such as an FPGA (e.g., Agilex™, Stratix®, Arria®, MAX®, or Cyclone® devices by Altera® Corporation), with a system design using a system design configuration 14. Note that, while this disclosure largely refers to the integrated circuit device 12 as being a programmable logic device, such as an FPGA, in some embodiments, the integrated circuit device 12 may also be a one-time programmable device or structured application specific integrated circuit (ASIC), such as an Intel® eASIC™ device by Intel® Corporation. In other examples, the integrated circuit device 12 may be any suitable integrated circuit that is manufactured to have a particular system design with circuitry to perform desired data processing operations. The integrated circuit device 12 may be a single monolithic integrated circuit or a multi-die system of integrated circuits. The integrated circuit device 12 may include a single integrated circuit, multiple integrated circuits in a package, or multiple integrated circuits in multiple packages communicating remotely (e.g., via wires or traces) and may be referred to as an integrated circuit device or an integrated circuit system whether formed from a single integrated circuit or multiple integrated circuits in a package.

A designer may desire to implement the system design 14 (sometimes referred to as a circuit design or configuration) to perform a wide variety of possible operations on the integrated circuit device 12. In some cases, the designer may specify a high-level program to be implemented, such as an OPENCL® program that may enable the designer to more efficiently and easily provide programming instructions to configure a set of programmable logic cells for the integrated circuit device 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

In a configuration mode of the integrated circuit device 12, a designer may use a data processing system 16 (e.g., a computer including a data processing system having a processor and memory or storage) to implement high-level designs (e.g., a system user design) using design software 18 (e.g., executable instructions stored in a tangible, non-transitory, computer-readable medium such as the memory or storage of the data processing system 16), such as a version of INTEL® QUARTUS® by INTEL CORPORATION. The data processing system 16 may use the design software 18 and a compiler 20 to convert the high-level program into a lower-level description (e.g., a configuration program, a bitstream) as the system design configuration 14. The compiler 20 may provide machine-readable instructions representative of the high-level program to a host 22 and the system design configuration 14 to the integrated circuit device 12.

Additionally or alternatively, the host 22 running the host program 24 may control or implement the system design configuration 14 onto the integrated circuit device 12. For example, the host 22 may communicate instructions from the host program 24 to the integrated circuit device 12 via a communications link 26 that may include, for example, direct memory access (DMA) communications or peripheral component interconnect express (PCIe) communications. The designer may use the design software 18 to generate and/or to specify a low-level program, using low-level tools such as the low-level hardware description languages described above. Further, in some embodiments, the system 10 may be implemented without a separate host 22 or host program 24. Thus, embodiments described herein are intended to be illustrative and not limiting.

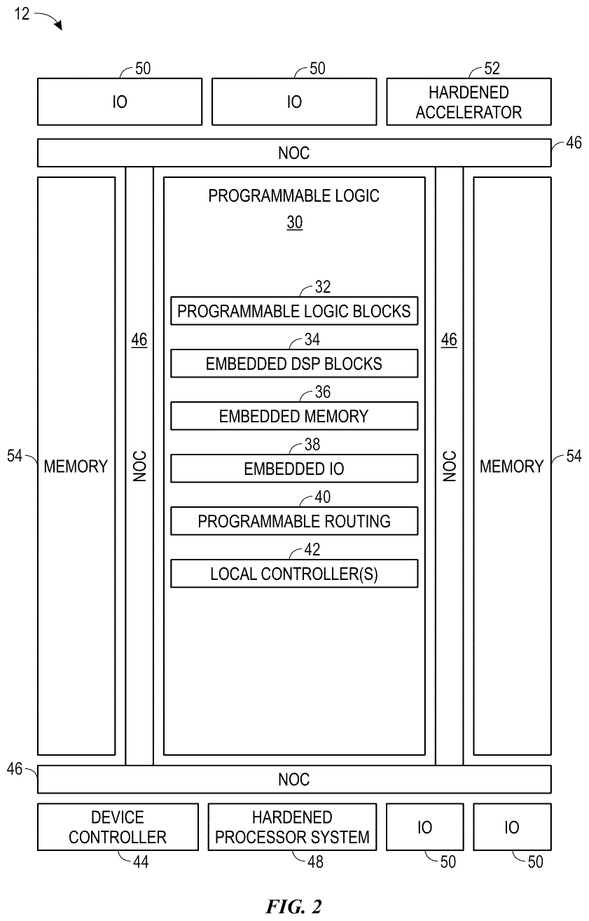

The integrated circuit device 12 may take any suitable form that may implement the system design configuration 14. In one example shown in FIG. 2, the integrated circuit device 12 may include programmable logic 30, which include a two-dimensional array of many different functional blocks, such as programmable logic blocks 32, embedded digital signal processing (DSP) blocks 34, embedded memory blocks 36, and embedded input-output blocks 38. In many cases, there may be rows or columns of these functional blocks that may be programmably connected to one another using programmable routing 40.

The programmable logic blocks 32 may be programmed to implement a wide variety of logic circuitry. The programmable logic blocks 32 may include a number of adaptive logic modules (ALMs), which may take the form of lookup tables (LUTs) that can be programmed to implement a logic truth table, effectively enabling any the programmable logic blocks 32 to implement any desired logic circuitry when configured with the system design configuration 14. The programmable logic blocks 32 and are sometimes referred to as logic array blocks (LABs) or configurable logic blocks (CLBs).

The embedded DSP blocks 34, embedded memory blocks 36, and embedded IO blocks 38 may be distributed around the programmable logic blocks 32. For example, there may be several columns of programmable logic blocks 32 for every column of DSP blocks 34, column of embedded memory blocks 36, or column of embedded IO blocks 38. The embedded DSP blocks 34 may include “hardened” circuits that are specialized to efficiently perform certain arithmetic operations. This is in contrast to “soft logic” circuits that may perform the same functions by programming the programmable logic blocks 32, but which may not be as efficient as the hardened circuits of the DSP blocks 34. The embedded memory blocks 36 may include dedicated local memory (e.g., blocks of 20 kB, blocks of 1 MB). The embedded IO blocks 38 may allow for certain inter-die or inter-package communication. The embedded DSP blocks 34, embedded memory blocks 36, and embedded IO blocks 38 may be accessible to the programmable logic blocks 32 using the programmable routing 40.

The various functional blocks of the programmable logic 30 may be grouped into programmable regions, sometimes referred to as logic sectors, that may be individually managed and configured by corresponding local controllers 42 (e.g., sometimes referred to as Local Sector Managers (LSMs)). The grouping of the programmable logic 30 resources on the integrated circuit device 12 into logic sectors, logic array blocks, logic elements, or adaptive logic modules is merely illustrative. In general, the integrated circuit device 12 may include functional logic blocks of any suitable size and type, which may be organized in accordance with any suitable logic resource hierarchy. Indeed, there may be other functional blocks (e.g., other embedded application specific integrated circuit (ASIC) blocks) than those shown in FIG. 2.

Before continuing, it may be noted that the programmable logic 30 circuitry of the integrated circuit device 12 may be controlled by programmable memory elements sometimes referred to as configuration random access memory (CRAM). Memory elements may be loaded with configuration data (also called programming data or a configuration bitstream) that represents the system design configuration 14. Once loaded, the memory elements may provide a corresponding static control signal that controls the operation of an associated functional block. In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, and the like. The configuration memory elements may use any suitable volatile and/or non-volatile memory structures such as random-access-memory (RAM) cells, fuses, antifuses, programmable read-only-memory (ROM) memory cells, mask-programmed, laser-programmed structures, or combinations of structures such as these.

A device controller 44, sometimes referred to as a secure device manager (SDM), may manage the operation of the integrated circuit device 12. The device controller 44 may include any suitable logic circuitry to control and/or program the programmable logic 30 or other elements of the integrated circuit device 12. For example, the device controller 44 may include a processor (e.g., an x86 processor or a reduced instruction set computer (RISC) processor, such as an Advanced RISC Machine (ARM) processor or a RISC-V processor) that executes instructions stored on any suitable tangible, non-transitory, machine-readable media (e.g., memory or storage). Additionally or alternatively, the device controller 44 may include a hardware finite state machine (FSM). The device controller 44 may provide other functions, such as serving as a platform for virtual machines that may manage the operation of the integrated circuit device 12.

A network-on-chip (NOC) 46 may connect the various elements of the integrated circuit device 12. The NOC 46 may provide rapid, packetized communication to and from the programmable logic 30 and other blocks, such as a hardened processor system 48, high-speed input-output (IO) blocks 50, a hardened accelerator 52, and local device memory 54. The integrated circuit device 12 may include the hardened processor system 48 when the integrated circuit device 12 takes the form of a system-on-chip (SOC). The hardened processor system 48 may include a hardened processor (e.g., an x86 processor or a reduced instruction set computer (RISC) processor, such as an Advanced RISC Machine (ARM) processor or a RISC-V processor) that may act as a host machine on the integrated circuit device 12. The high-speed IO blocks 50 may enable communication using any suitable communication protocol(s) with other devices outside of the integrated circuit device 12, such as a separate memory device. The hardened accelerator 52 may include any hardened application-specific integrated circuitry (ASIC) logic to perform a desired acceleration function. For example, the hardened accelerator 52 may include hardened circuitry to perform cryptographic or media encoding or decoding. The memory 54 may provide local device memory (e.g., cache) that may be readily accessible by the programmable logic 30.

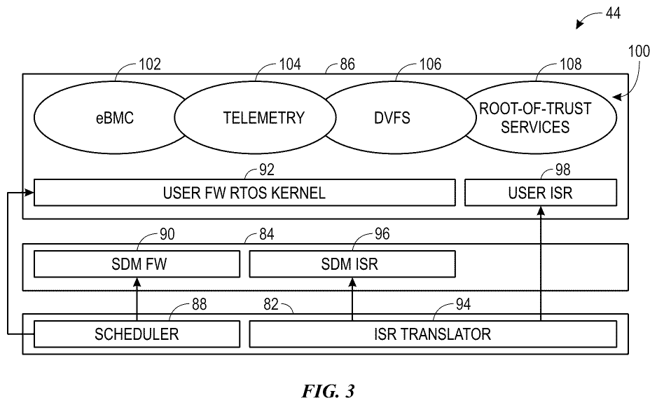

The device controller 44 may use virtualization to facilitate secure device management and platform management operations. This allows the integrated circuit device 12 to be managed more efficiently, with or without a separate board management controller. Virtualization allows the creation of multiple simulated environments, operating systems (OS), or dedicated resources from a single, physical hardware system. As shown in FIG. 3, virtualization may be implemented using any suitable computation environment manager that manages multiple containerized environments. In the specific examples that follow, software such as a hypervisor 82 that runs on the device controller 44 may be used to manage other software known as a “guest” or virtual machine, but these are intended as examples are not meant to be exhaustive. A virtual machine is software that, when executed on appropriate hardware, creates an environment allowing for the abstraction of an actual physical computer system also referred to as a “host” or “host machine.” In other words, a virtual machine is software that simulates a physical computer system. There may be multiple virtual machines running on a single host machine. Like physical computer systems, each virtual machine may run its own guest operating system (OS) and applications, as well as interact with peripheral devices such as Peripheral Component Interconnect express (PCIe) devices. Each virtual machine can operate independently of other virtual machines and yet use the same hardware resources. The hypervisor 82 may be referred to as a “micro-hypervisor” that is lightweight enough to operate on the device controller 44.

In the example of FIG. 3, the hypervisor 82 manages a first virtual machine referred to as a secure device machine (SDM) 84 and a second virtual machine referred to as a platform management machine (PMM) 86. Additionally or alternatively, there may be other containerized modules (e.g., virtual machines), such as a user machine to separately run user applications or a root-of-trust (RoT) machine to separately run authentication services. In the example of FIG. 3, the PMM 86 runs the user applications and root-of-trust authentication services on the same machine. In effect, the use of the hypervisor 82 on the device controller 44 allows the use of containers for device management via virtual machines. Due to the separate containerized virtual machines on the integrated circuit device 12, implementation of standardized functionality such as root-of-trust services such as Calyptra may be gained.

The various containerized modules such as the SDM 84 and the PMM 86, as well as any others, may be provided by and/or operate on behalf of the same entities or different entities. In one example, the hypervisor 82, the SDM 84, and the PMM 86 may be provided by a manufacturer of the integrated circuit device 12 and a user application machine may be provided by a user of the integrated circuit device 12. In another example, the hypervisor 82 and the SDM 84 may be provided by a manufacturer of the integrated circuit device 12 and the PMM 86 may be provided by a different party (e.g., a third-party platform management software company or a user of the integrated circuit device 12). These entities are also provided by way of example; it should be understood that these examples are not intended to be exhaustive.

The hypervisor 82 may abstract a physical layer of the device controller 44, presenting this abstraction to the SDM 84 and the PMM 86 and any other virtual machines that may be hosted on the device controller 44. In this way, the hypervisor 82 may provide a virtual operating platform for the virtual machines. A scheduler 88 of the hypervisor 82 may provide scheduling instructions to SDM firmware (FW) 90 running on the SDM 84 and to a user FW real-time operating system (RTOS) kernel 92. The hypervisor 82 may also include an interrupt service routine (ISR) and event translator 94 provide services to an SDM ISR 96 running on the SDM 84 and a user ISR 98 running on the PMM 86. The Interrupt Service Routines and Event Translation between different machines may be implemented on the hypervisor 82 so as to achieve real time interrupt latencies by running in a true machine mode (e.g., directly on a processor of the device controller 44 rather than on a virtual machine).

The SDM 84 may perform any suitable secure device management operations, such as authenticating and loading the system design configuration 14 onto the programmable logic circuitry 30 of the integrated circuit device 12. The SDM 84 may be a secure (e.g., encrypted, authenticated) image that always executes from local random access memory (RAM) of the integrated circuit device. Interrupt allocation for the SDM 84 may be provided during configuration (e.g., the ISR vector may be auto-generated). The scheduler 88 of the hypervisor 82 may be given a configuration to define an allocation of the physical resources of the device controller 44 to be allotted to the SDM 84 and the PMM 86. In some embodiments, the SDM 84 may operate as a device security manager (DSM) that may implement protocols that enable trusted execution environment (TEE) security through hardware-level software isolation, such as protocols that are part of Intel® Trust Domain Extensions (TDX)-connect or WorldGuard for RISC-V, providing a secure operating system (OS) to trust code on the integrated circuit device 12.

The PMM 86 provides user control of virtual resources and support for peripheral devices, such as flash memory or storage devices, supported per user definition. The PMM 86 allows for discrete control of platform devices using third-party user code without separate code from the manufacture of the integrated circuit device 12. In other words, the PMM 86 allows for secure hybrid control of the integrated circuit device 12 (separating manufacturer control from user control). In the example of FIG. 3, the PMM 86 also hosts a number of platform and user services 100. These include an embedded board management controller (eBMC) module 102 to perform board management functions, a telemetry module 104 to collect and monitor operational data about the integrated circuit device 12 (e.g., voltage levels, thermal measurements, FPGA resource utilization, clock frequencies, and so on) that may be used by the eBMC module 102, a dynamic voltage and frequency scaling (DVFS) module 106 to dynamically control the voltage and frequency of the integrated circuit device 12 to achieve greater device efficiency, and a root-of-trust services module 108 to perform authentication (e.g., via services such as Calyptra). The PMM 86 may also run any other suitable user applications.

The PMM 86 may run based on a secure or a non-secure image. In some cases, the PMM 86 may run in execute-in-place (XIP) mode, executing directly from storage (e.g., flash memory storage) where the image is stored. The user FW RTOS kernel 92 may be a lightweight real-time operating system that may run on the PMM 86 without a separate memory management unit (MMU). The final image of the PMM 86 may be directly loadable into memory. The platform and user services 100 that run on the PMM 86 may be callable directly as an application programming interface (API) call. For example, the eBMC module 102 or DVFS module 106 may call APIs of the SDM firmware 90 (e.g., power management or configuration/reconfiguration APIs). Moreover, specific APIs of the SDM firmware 90 entry points may be exportable.

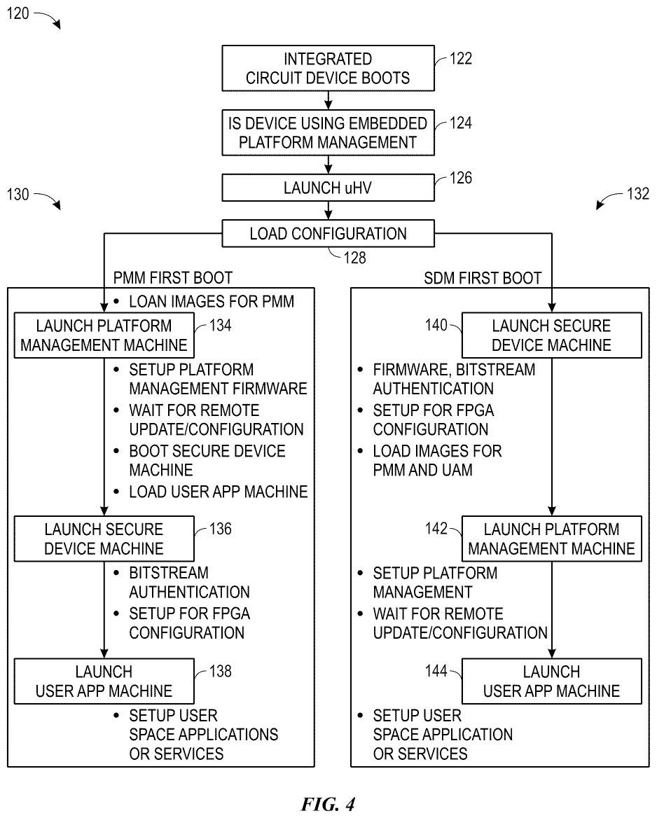

As shown by a flowchart 120 of FIG. 4, the hypervisor 82 may follow a variety of different boot sequences to load the SDM 84 or another virtual machine such as the PMM 86 first. As the integrated circuit device boots (process block 122), it may be determined whether the integrated circuit device 12 is using embedded platform management (process block 124). If not, the device controller 44 may boot into an ordinary, non-containerized secure device manager to bring up the integrated circuit device 12. If the integrated circuit device 12 is using embedded platform management (process block 124), the device controller 44 may launch the hypervisor 82 (process block 126). Depending on a boot mode configuration (process block 128), the hypervisor 82 may perform a PMM first boot 130 or an SDM first boot 132. The boot mode configuration may be set in a configuration register in the integrated circuit device or may be loaded from an external source (e.g., memory comprising the system design configuration, a signal received via the IO 50 from a remote device).

In the case of the PMM 86 first boot 130, the hypervisor 82 may initially load images for the PMM 86 and launch the launch the PMM 86 (process block 134). The PMM 86 may set up platform management firmware such as the user FW RTOS kernel 92, which may wait for a remote update or further configuration. The hypervisor 82 may also begin to boot the SDM 84 and, if the device controller 44 is to run a separate user application machine, the hypervisor 82 may also load the user application machine. The hypervisor 82 may launch the SDM 84 (process block 136) and the SDM 84 may begin bitstream authentication and other FPGA configuration operations. The hypervisor 82 may subsequently launch the user application machine and/or any other virtual machines (process block 138). The user application machine may set up user space applications or services that may run on the user application machine.

In the case of the SDM 84 first boot 132, the hypervisor 82 may initially launch the SDM 84 (process block 140). The SDM 84 may perform bitstream authentication and other FPGA configuration operations. The hypervisor 82 may also load images for the PMM 86 and, if the device controller 44 is to run a separate user application machine, the user application machine. The hypervisor 82 may launch the PMM 86 (process block 142) and the PMM 86 may set up platform management firmware such as the user FW RTOS kernel 92, which may wait for a remote update or further configuration. The hypervisor 82 may subsequently launch the user application machine and/or any other virtual machines (process block 144). The user application machine may set up user space applications or services that may run on the user application machine.

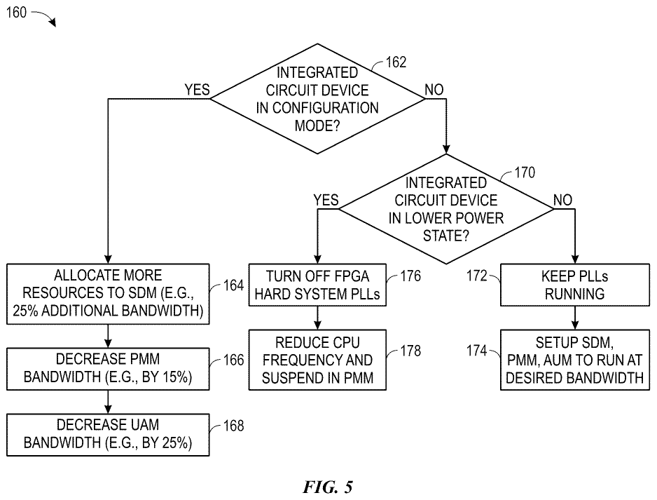

The device controller 44 may be capable of running at least the SDM 84, the PMM 86, and the user application machine (if present) in sufficient real time at a guaranteed quality of service (QoS) level. For example, the device controller 44 may intelligently manage its total bandwidth according to a method shown by a flowchart 160 of FIG. 5. The device controller 44 may determine if the integrated circuit device 12 is operating in a configuration mode (decision block 162). If so, the hypervisor 82 may allocate more physical resources of the device controller 44 to the SDM 84 (e.g., additional 25% of processor bandwidth) to enable the SDM 84 to perform the configuration of the integrated circuit device 12. The hypervisor 82 may allocate fewer resources to the other virtual machines on the device controller 44. For example, the hypervisor 82 may decrease the bandwidth of the PMM 86 (e.g., by 15%) (process block 166) and may decrease the bandwidth of the user application machine (if present) (e.g., by 25%) (process block 168).

If the integrated circuit device 12 is not operating in a configuration mode (decision block 162), the device controller 44 may determine if the integrated circuit device is operating in a low-power state (decision block 170). If so, the device controller 44 (e.g., the SDM 84) may turn off hardened system clock generators (e.g., phase-locked loops (PLLs)) (process block 176) and reduce the overall operating frequency of the processor of the device controller 44 and the hypervisor may suspend the PMM 86 (process block 178). If the integrated circuit device is not operating in a low-power state (decision block 170), the device controller 44 may keep the hardened system clock generators running (process block 172) and the hypervisor 82 may set up the SDM 84, the PMM 86, and, if present, the user application machine (UAM) to run at a desired bandwidth of the processor of the device controller 44. Table 1 below provides one example of bandwidth allocation that may be used during normal operation. In any case, the software running on the device controller 44 may operate in a soft real-time basis (e.g., having guaranteed response latencies to user events).

TABLE 1
Bandwidth Allocation during Normal Operation

| | |
|---|---|
| Interrupts and Events Handling | 2% |
| Hypervisor 82 | 20% |
| SDM 84 | 15% |
| PMM 86 | 30% |
| UAM | 30% |

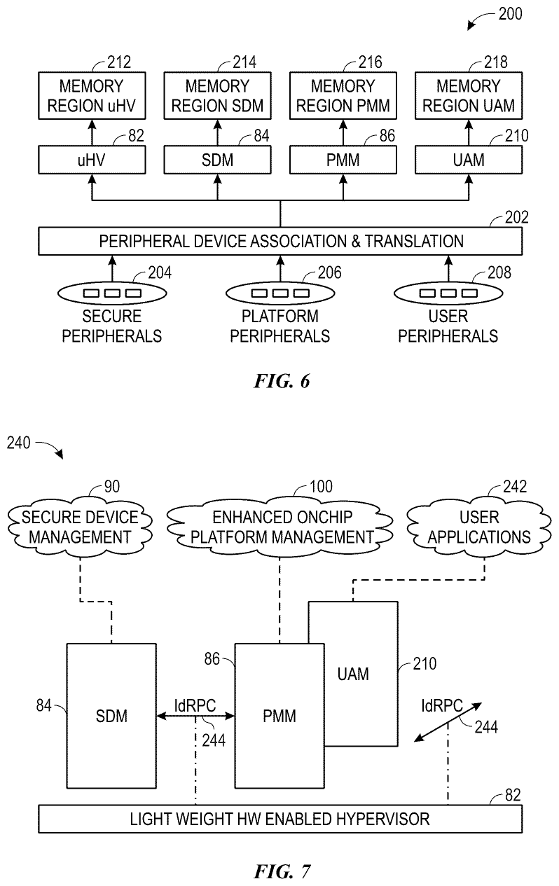

The hypervisor 82 running on the device controller 44 may provide individual programmable set of address spaces for different virtual machines to provide and manage the respective software. For instance, as shown by a resource allocation block diagram 200 in FIG. 6, a peripheral device association and translation layer 202 may provide lightweight translation that provides a transfer of peripheral events and access to respective machines. Peripherals that may be allocated include secure peripherals 204 that may be allocated to the SDM 84, platform peripherals 206 that may be allocated to the PMM 86, and user peripherals 208 that may be allocated to a user application machine (UAM) 210, which may allow a user to deploy an operating system for real-time control of the integrated circuit device 12. There may also be a hypervisor memory region 212 securely accessible by the hypervisor 82, an SDM memory region 214 securely accessible by the SDM 84, a PMM memory region 216 securely accessible to the PMM 86, and a UAM memory region 218 securely accessible to the UAM 210. These peripherals 204, 206, and 208 and the memory regions 212, 214, 216, and 218 may be associated statically or dynamically allocated by the SDM 84 and hypervisor 82 to themselves and the other machines.

Each of the machines 84, 86, and 210 may utilize an individual port or shared port and may have access to their respective devices 204, 206, and 208. For example, the SDM 84 and PMM 86 may share an Octal Serial Peripheral Interface (OSPI) physical port, but two different devices 204, 206 or regions 214, 216 may be available on the same OSPI port which each device 204, 206 may individually access. Another example is that multiple devices 204, 206, or 208 may be present on a single power management bus (PMBUS) physical port. The access to an external device 204, 206, or 208 on the PMBUS may be orchestrated by the hypervisor peripheral device association and translation layer 202. Another example is that the SDM 84, PMM 86 and UAM 210 may each have exclusive access to a peripheral device 204, 206, or 208 (e.g., the SDM 84 may have exclusive access to Ethernet MAC 0, GPIO 1-16; the PMM 86 may have exclusive access to Ethernet MAC 1, GPIO 17-32; the UAM 210 may have exclusive access to Ethernet MAC2). This may be possible in part because each virtual machine is software that is independently loadable and executable without interference from one another.

Another benefit of the containerized system of this disclosure is shown by a communication diagram 240 of FIG. 7. Indeed, the secure software of the SDM 84 may provide software APIs to directly call from one virtual machine to another. In the example of FIG. 7, the hypervisor 82 is shown supporting the SDM 84, the PMM 86, and the UAM 210. The SDM 84 runs secure device management software such as the SDM FW 90. The PMM 86 runs enhanced onchip platform management software such as the platform and user services 100. The UAM 210 runs any user applications 242 that a user of the integrated circuit device 12 may desired to run. The individual virtual machines 84, 86, 210, and any others that may be supported by the hypervisor 82, may communicate using calls 244 according to the local direct remote procedure call (ldRPC) protocol. This method, ldRPC, enables very low latency input/output (IO) calls between callers and callees.

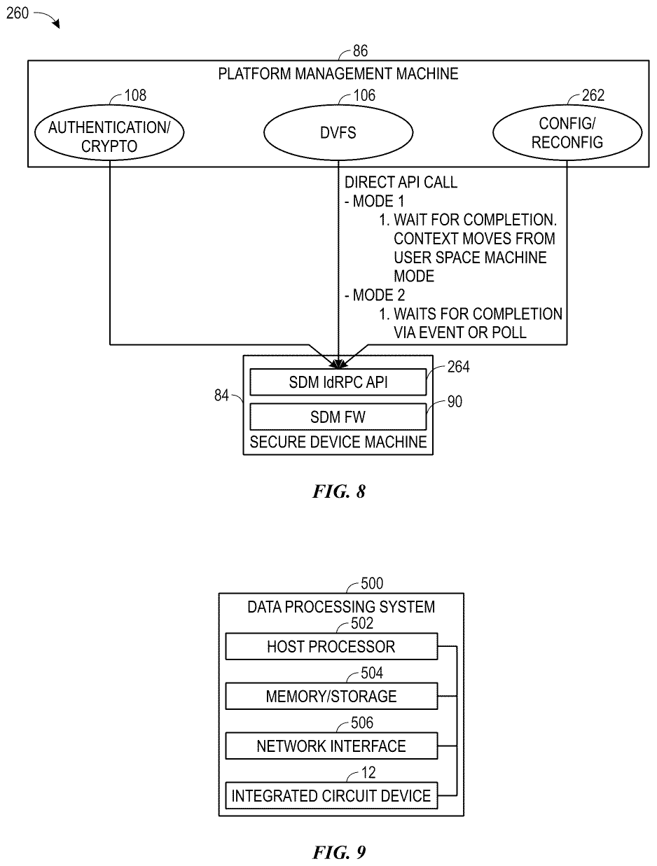

As shown in FIG. 8, different tasks running on the PMM 86, such as the root-of-trust services module 108 carrying out operations such as authentication and cryptography, the dynamic voltage and frequency scaling (DVFS) module 106, and other modules such as a configuration and reconfiguration module 262 may use ldRPC to communicate and make use of the services of the SDM 84. For example, an SDM ldRPC API 264 may reside on the SDM 84 and may interact with the SDM FW 90. The direct API call may operate in a selectable mode. In a first mode, the PMM 86 or other machine may wait for completion of the API call of the SDM 84. To do so, context may move from a user space machine mode. In a second mode, the PMM 86 may wait for completion via an event or poll. Recall that an ldRPC call happens within the context of the same processor. Since the independent virtual machines of this disclosure are virtually located on single physical machine (in the example of this disclosure, the device controller 44), the inter-processor communication delays are greatly reduced to an equivalent of a function call on the same processor.

The integrated circuit device 12 discussed above may be a component included in a data processing system, such as a data processing system 500, shown in FIG. 9. The data processing system 500 may include the integrated circuit device 12 (e.g., a programmable logic device, an application specific integrated circuit (ASIC)), a host processor 502, memory and/or storage circuitry 504, and a network interface 506. The data processing system 500 may include more or fewer components (e.g., electronic display, user interface structures, application specific integrated circuits (ASICs)). Moreover, any of the circuit components depicted in FIG. 8 may include the containerized operations of the integrated circuit device 12. The host processor 502 may include any of the foregoing processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams) for programming the integrated circuit device 12. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as cities, states, or countries.

The data processing system 500 may be part of a data center that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. To provide only a few examples, these may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. An integrated circuit device comprising:
programmable logic circuitry; and
a device controller comprising a processor to execute instructions stored on one or more tangible, non-transitory, machine-readable media to run:
   a hypervisor;
   a first virtual machine managed by the hypervisor, wherein the first virtual machine performs a configuration function of the programmable logic circuitry; and
   a second virtual machine managed by the hypervisor, wherein the second virtual machine performs a platform management function of the integrated circuit device.
EXAMPLE EMBODIMENT 2. The integrated circuit device of example embodiment 1, wherein the first virtual machine is a secure virtual machine that operates in a trust domain.
EXAMPLE EMBODIMENT 3. The integrated circuit device of example embodiment 2, wherein the first virtual machine implements protocols according to Trust Domain Extensions (TDX).
EXAMPLE EMBODIMENT 4. The integrated circuit device of example embodiment 1, wherein the first virtual machine always executes from local memory of the integrated circuit device.
EXAMPLE EMBODIMENT 5. The integrated circuit device of example embodiment 1, wherein the configuration function comprises authenticating a system design configuration of the programmable logic circuitry of the integrated circuit device.
EXAMPLE EMBODIMENT 6. The integrated circuit device of example embodiment 5, wherein the configuration function comprises loading the authenticated system design configuration onto the programmable logic circuitry of the integrated circuit device.
EXAMPLE EMBODIMENT 7. The integrated circuit device of example embodiment 1, wherein the second virtual machine executes from an image in an external memory.
EXAMPLE EMBODIMENT 8. The integrated circuit device of example embodiment 1, wherein the second virtual machine runs from a non-authenticated image.
EXAMPLE EMBODIMENT 9. The integrated circuit device of example embodiment 1, wherein the second virtual machine runs from an authenticated image.
EXAMPLE EMBODIMENT 10. The integrated circuit device of example embodiment 1, wherein the second virtual machine comprises an embedded board management controller module that runs on the second virtual machine.
EXAMPLE EMBODIMENT 11. The integrated circuit device of example embodiment 1, wherein the second virtual machine comprises a root-of-trust services module, a dynamic voltage and frequency scaling (DVFS) module, a configuration or reconfiguration module, or a telemetry module, or any combination thereof.
EXAMPLE EMBODIMENT 12. The integrated circuit device of example embodiment 1, wherein the processor executes instructions stored on the one or more tangible, non-transitory, machine-readable media to run a third virtual machine managed by the hypervisor, wherein the third virtual machine comprises a user application.
EXAMPLE EMBODIMENT 13. The integrated circuit device of example embodiment 1, wherein the hypervisor runs in true machine mode on the processor, wherein the processor comprises a Reduced Instruction Set Computing-Five (RISC-V) processor.
EXAMPLE EMBODIMENT 14. A method comprising:
powering up an integrated circuit device comprising programmable logic circuitry and a hardened processor;
launching a hypervisor on the hardened processor;
when the integrated circuit device has a first load configuration, using the hypervisor to launch a platform management virtual machine to manage the integrated circuit device first and then launching a secure device virtual machine to manage the programmable logic circuitry second; and
when the integrated circuit device has a second load configuration, using the hypervisor to launch the secure device virtual machine first and then the platform management virtual machine second.
EXAMPLE EMBODIMENT 15. The method of example embodiment 14, comprising, when the integrated circuit device has the first load configuration or when the integrated circuit device has the second load configuration, using the hypervisor to launch a user application virtual machine to run user space applications or services.
EXAMPLE EMBODIMENT 16. The method of example embodiment 14, comprising when the integrated circuit device is in a programmable logic circuitry configuration mode, using the hypervisor to adjust resource allocation of the hardened processor between the secure device virtual machine and the platform management virtual machine.
EXAMPLE EMBODIMENT 17. The method of example embodiment 16, wherein using the hypervisor to adjust the resource allocation of the hardened processor comprises reducing resources to the platform management virtual machine by a first amount and increasing resources to the secure device virtual machine by a second amount, wherein the second amount is greater than the first amount in relative terms.
EXAMPLE EMBODIMENT 18. The method of example embodiment 14, comprising, when the integrated circuit device enters a lower-power mode, using the hypervisor to reduce a frequency of the hardened processor.
EXAMPLE EMBODIMENT 19. An article of manufacture comprising one or more tangible, non-transitory computer readable media comprising instructions that, when executed by a hardened processor of an integrated circuit device installed on a printed circuit board, cause the hardened processor to run:
a hypervisor provided by a first party to manage a plurality of virtual machines;
a first virtual machine of the plurality of virtual machines provided by the first party to perform secure device management of the integrated circuit device and provide an application programming interface (API) accessible to a second virtual machine of the plurality of virtual machines provided by a second party; and
the second virtual machine, wherein the second virtual machine is to perform board management operations associated with the integrated circuit device and communicate with the first virtual machine via the API.
EXAMPLE EMBODIMENT 20. The article of manufacture of example embodiment 19, wherein the second virtual machine is to call the API via a local direct remote procedure call.

What is claimed is:

1. An integrated circuit device comprising:
programmable logic circuitry; and
a device controller comprising a processor to execute instructions stored on one or more tangible, non-transitory, machine-readable media to run:
a hypervisor;
a first virtual machine managed by the hypervisor, wherein the first virtual machine performs a configuration function of the programmable logic circuitry; and
a second virtual machine managed by the hypervisor, wherein the second virtual machine performs a platform management function of the integrated circuit device.

2. The integrated circuit device of claim 1, wherein the first virtual machine is a secure virtual machine that operates in a trust domain.

3. The integrated circuit device of claim 2, wherein the first virtual machine implements protocols according to Trust Domain Extensions (TDX).

4. The integrated circuit device of claim 1, wherein the first virtual machine always executes from local memory of the integrated circuit device.

5. The integrated circuit device of claim 1, wherein the configuration function comprises authenticating a system design configuration of the programmable logic circuitry of the integrated circuit device.

6. The integrated circuit device of claim 5, wherein the configuration function comprises loading the authenticated system design configuration onto the programmable logic circuitry of the integrated circuit device.

7. The integrated circuit device of claim 1, wherein the second virtual machine executes from an image in an external memory.

8. The integrated circuit device of claim 1, wherein the second virtual machine runs from a non-authenticated image.

9. The integrated circuit device of claim 1, wherein the second virtual machine runs from an authenticated image.

10. The integrated circuit device of claim 1, wherein the second virtual machine comprises an embedded board management controller module that runs on the second virtual machine.

11. The integrated circuit device of claim 1, wherein the second virtual machine comprises a root-of-trust services module, a dynamic voltage and frequency scaling (DVFS) module, a configuration or reconfiguration module, or a telemetry module, or any combination thereof.

12. The integrated circuit device of claim 1, wherein the processor executes instructions stored on the one or more tangible, non-transitory, machine-readable media to run a third virtual machine managed by the hypervisor, wherein the third virtual machine comprises a user application.

13. The integrated circuit device of claim 1, wherein the hypervisor runs in true machine mode on the processor, wherein the processor comprises a Reduced Instruction Set Computing-Five (RISC-V) processor.

14. A method comprising:
powering up an integrated circuit device comprising programmable logic circuitry and a hardened processor;
launching a hypervisor on the hardened processor;
when the integrated circuit device has a first load configuration, using the hypervisor to launch a platform management virtual machine to manage the integrated circuit device first and then launching a secure device virtual machine to manage the programmable logic circuitry second; and
when the integrated circuit device has a second load configuration, using the hypervisor to launch the secure device virtual machine first and then the platform management virtual machine second.

15. The method of claim 14, comprising, when the integrated circuit device has the first load configuration or when the integrated circuit device has the second load configuration, using the hypervisor to launch a user application virtual machine to run user space applications or services.

16. The method of claim 14, comprising when the integrated circuit device is in a programmable logic circuitry configuration mode, using the hypervisor to adjust resource allocation of the hardened processor between the secure device virtual machine and the platform management virtual machine.

17. The method of claim 16, wherein using the hypervisor to adjust the resource allocation of the hardened processor comprises reducing resources to the platform management virtual machine by a first amount and increasing resources to the secure device virtual machine by a second amount, wherein the second amount is greater than the first amount in relative terms.

18. The method of claim 14, comprising, when the integrated circuit device enters a lower-power mode, using the hypervisor to reduce a frequency of the hardened processor.

19. An article of manufacture comprising one or more tangible, non-transitory computer readable media comprising instructions that, when executed by a hardened processor of an integrated circuit device installed on a printed circuit board, cause the hardened processor to run:
a hypervisor provided by a first party to manage a plurality of virtual machines;
a first virtual machine of the plurality of virtual machines provided by the first party to perform secure device management of the integrated circuit device and provide an application programming interface (API) accessible to a second virtual machine of the plurality of virtual machines provided by a second party; and
the second virtual machine, wherein the second virtual machine is to perform board management operations associated with the integrated circuit device and communicate with the first virtual machine via the API.

20. The article of manufacture of claim 19, wherein the second virtual machine is to call the API via a local direct remote procedure call.
